(19) United States
(12) Patent Application Publication
(10) Pub. No.: US 2004/0227407 A1
(43) Pub. Date: Nov. 18, 2004

(54) Proximity detector, portable computer, proximity detection method, and program

(75) Inventor: Masahiko Nagai, Fujisawa-shi (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/766,462

(22) Filed: Jan. 28, 2004

(30) Foreign Application Priority Data
Jan. 29, 2003 (JP) 2003-019805

(51) Int. Cl. H01H 1/00

(52) U.S. Cl. 307/112; 340/686.1

(57) ABSTRACT

A proximity detector includes an element which contactlessly exerts a predetermined action from a first member or portion; a detector which detects, in a second member or portion, the receipt of the action of a predetermined intensity or more; and an inhibitor which prevents, in the first portion, the element from exerting the action. When the detector detects the receipt of the action of predetermined intensity or more, the inhibitor prevents the exertion of the action, and a determination is made whether or not the first member or portion is proximate to the second member or portion based on an output of the detector in response to the prevention of the action.

### FIELD AND BACKGROUND OF INVENTION

The present invention relates to a proximity detector and a proximity detection method for detecting whether or not a first member is proximate to a second member, a portable computer using the proximity detector and the proximity detection method, and a program for allowing the portable computer to execute the steps of the proximity detection method.

In general, in a notebook type PC, measures are taken for the purpose of reducing power consumption when the PC is used with a battery, such as adopting a function to allow the PC to shift to a power saving mode. Moreover, it is known is systems of such types to configure a system to automatically shift to the power saving mode when a lid in which a display is provided is closed because the PC becomes unusable and unused in this state. In this case, it is necessary to judge whether or not the lid is closed. One way of making such a judgment has been to use a magnet and a Hall effect switch which detects a magnetic field formed by the magnet. Such judgment mechanism formed by this combination has advantages in that it is possible to contactlessly detect opening/closing of the lid, tolerance is large, and reliability is high.

FIG. 4 of the accompanying drawings shows a notebook PC according to a conventional example, in which the judgment mechanism as described above is provided. This notebook PC includes a body 101 in which a keyboard is provided on an upper surface thereof, and a lid 103 pivotally attached to the body 101 through a hinge 102. In the lid 103, a liquid crystal display device important for interfacing with an operator is provided on a side facing the body 101 when the lid 103 is closed. A magnetic detector or sensor 104 using a Hall effect switch is provided in an end portion of the body 101 on the opposite side to the hinge 102. A magnet 105 is provided in a portion of the lid 103 which moves into proximity with the magnetic sensor 104. When the Hall effect switch is turned on, a power management system of the notebook PC shifts to a power saving mode such as a standby mode or a suspend mode, thus preventing a waste of electric power. The body 101 and lid 103 define first and second members movable one relative to the other.

In this configuration, as the magnet 105 becomes proximate to the magnetic sensor 104 when the lid 103 is being closed, a magnetic field from the magnet 105 comes to exert a significant influence on the magnetic sensor 104. Then, when the lid 103 comes in a completely closed state, the magnetic sensor 104 comes into an ON-output state. The power management system of the notebook PC shifts to the power saving mode such as the standby mode based on an ON output from the magnetic sensor 104.

It is also known, in a device for displaying an image by use of a cathode-ray tube, to provide an automatic cancel system which prevents an electron beam generated by an electron gun from being deviated from its original path because of an influence of a geomagnetism and prevents an image from being disturbed (for example, refer to Japanese Patent Laid-Open No. H10-197614 (published in 1998)). This system is configured to detect the geomagnetism, to generate a magnetic field in a direction reverse to that of the geomagnetism to cancel the geomagnetism, and to thereby prevent the image from being disturbed.

However, the above-described opening/closing judgment mechanism using a magnet and magnetic sensor in the conventional notebook PC has the following possible problems. Specifically, when a magnet clip is present in the vicinity of the notebook PC or an operator wears a magnetic accessory, as shown in FIG. 5, the magnetic sensor 104 may malfunction because of a magnetic field formed by a magnet 106 included in the magnet clip or the magnetic accessory, and the notebook PC may shift to the power saving mode to be halted even though the lid 103 is not closed. Moreover, a malfunction may occur in a similar way also when the notebook PC is located under an environment of an intense magnetic field such as one in which an electric furnace is present in the vicinity.

### SUMMARY OF THE INVENTION

In consideration of the problems of the conventional technology as described above, it is a purpose of the present invention to provide a technology capable of preventing erroneous detection of the proximity of a first member or portion to a second member or portion because of an influence of a stray or accidental magnetic field.

In realizing this purpose, apparatus according to the present invention includes: an element mounted in one of said members which initiates an action in the apparatus, a detector mounted in the other of the members which responds to the proximity of and detects the intensity of interaction with the element; and an inhibitor mounted in the one member which selectively inhibits the intensity of interaction between the element and the detector. The inhibitor, element and detector cooperate in determining the physical proximity of the members one relative to the other and enabling an effective intensity of interaction between the element and the detector when the members are in close proximity one to the other.

Moreover, a proximity detection method according to the present invention is one for detecting proximity of a first portion to a second portion, the first portion being provided with action application means for contactlessly exerting a predetermined action, and the method includes the steps of: detecting, in a second portion, receipt of the action of a predetermined intensity or more; preventing, in the first portion, the action application means from exerting the action in response to the detection of the action; and judging whether or not the first portion is proximate to the second portion based on a change in a detection state of the action in the second portion caused by the prevention of the action.

Here, as the action, for example, an action by means of an electromagnetic wave, an electric field, a magnetic field, a corpuscular radiation or an acoustic wave is applicable. As the electromagnetic wave, for example, a visible radiation, an ultraviolet ray, an infrared ray or an electric wave is applicable. As the corpuscular radiation, for example, an electron beam is applicable. As the action application means, for example, a magnet, an electroluminescent (EL) device or an electron emitting device such as a cold cathode device is applicable. As the action detection means, for example, a Hall effect switch, a lead switch, a charge-coupled device (CCD) or a photodetector is applicable. As the action prevention means, for example, a coil for canceling a magnetic field, a liquid crystal shutter shielding light, or an electromagnetic shield shielding an electromagnetic field is applicable. As the first and second portions, part of any opening and closing thing and part of the other corresponding thereto, for example, in the case of a notebook PC, a refrigerator, a washing machine, a door, a sliding door or the like, are applicable.

In this configuration, when the first portion approaches the second portion, and the action exerted by the action application means of the first portion reaches a predetermined intensity in the second portion, it is detected in the second portion that the action has reached the predetermined intensity. However, if something else other than the first portion in the vicinity of the second portion also exerts the same type of action as that exerted by the action application means, there is no guarantee that the detected action is always one from the first portion. In such a case, the detection of the action of the predetermined intensity does not always depend on a fact that the first portion is proximate to the second portion. Therefore, when it is judged that the first portion is proximate to the second portion based on the detection of the action of the predetermined intensity, erroneous detection may occur in some cases.

Accordingly, in the present invention, the action application means is attempted to be prevented from exerting the action after the action of the predetermined intensity is detected in the second portion, and it is judged whether or not the first portion is proximate to the second portion based on a detection state of the action in the second portion in response to the prevention of the exertion of the action. According to this, if the action of the predetermined intensity can be detected in the second portion when the action is prevented in the first portion, the detected action is not one from the action application means of the first portion but one from something else. Accordingly, it can be judged that the first portion is not proximate to the second portion. On the other hand, if the action of the predetermined intensity cannot be detected in response to the prevention of the action in the first portion, the action is certainly the one from the first portion. Accordingly, it can be judged that the first portion is proximate to the second portion. Thus, even if other portions exert the same type of action as that from the first portion, the erroneous detection of the proximity of the first portion to the second portion can be prevented.

In a preferred aspect of the present invention, as the action application means, one requiring no supply of energy for exerting the action from an outside is used. In this case, it is not necessary to supply the energy in order to exert the action, and it is sufficient to supply the energy for preventing the action only when the action is detected in the second portion. Accordingly, the erroneous detection can be prevented with energy consumption as minimum as possible. Therefore, it is useful to apply the action application means to a product driven by a battery, such as a notebook PC. As the action application means requiring no supply of the energy, for example, the magnet is applicable.

If the action exerted by the action application means of the first portion is an action by the magnetic field, as the action detection means of the second portion, one including a Hall effect switch which is turned on/off by the action of the magnetic field can be used. Meanwhile, as the action prevention means of the first portion, a coil which forms a magnetic field inversely extending to cancel the magnetic field exerted by the action application means can be used.

Moreover, instead of this, the action exerted by the action application means of the first portion may be an action by light, the action detection means of the second portion may include photoelectric conversion means for converting a signal of the light into an electrical signal, and the action prevention means of the first portion may include means for shielding the light. As the photoelectric conversion means, for example, a photodetector or a CCD can be used.

As the first portion, for example, part of a lid in a portable computer including a body in which a keyboard is provided and the lid which is pivotally connected to the body through a hinge to be openable and has a display, is applicable. In this case, as the second portion, part of the body, which is proximate to the part of the lid when the lid is closed, is applicable. That is, it is detected whether or not the lid is closed.

The action can be prevented by the action prevention means in a manner of driving the action prevention means by a predetermined coded driving signal, and it can be judged whether or not the first portion is proximate to the second portion based on whether or not the output of the action detection means corresponds to the driving signal. According to this, it can more securely be detected whether or not the action by the action application means is prevented by the action prevention means based on the output of the action detection means, and it can more securely be judged whether or not the first portion is proximate to the second portion.

Meanwhile, a portable computer according to the present invention includes: a body in which a keyboard is provided; and a lid which is pivotally connected to the body through a hinge to be openable and provided with a display having a display screen on a side facing the keyboard when closed. Moreover, the portable computer includes a proximity detector for detecting whether or not a first portion as part of the lid is proximate to a second portion as part of the body to which the first portion becomes proximate when the lid is closed, wherein this proximity detector is the above-described proximity detector of the present invention. Here, as the portable computer, for example, a notebook type personal computer (notebook PC), a subnotebook type personal computer or a palmtop type personal computer is applicable.

In this case, it can be detected that the lid is closed by detecting that the first portion is proximate to the second portion. When it is detected that the lid is closed, the portable computer can shift to a power saving mode. Since it can be detected that the lid is closed without any error by use of the proximity detector, the portable computer can be prevented from erroneously shifting to the power saving mode while being in service.

As the action application means, for example, a magnet fixed to the first portion can be used. As the action detection means, one having a Hall effect switch can be used. As the action prevention means, one including a coil, fixed to the first portion, for forming a magnetic field which cancels a magnetic field from the magnet can be used. The portable computer can include a micro processing unit (MPU) for controlling drive of the coil and judging whether or not the first portion is proximate to the second portion, based on the output of the action detection means.

Another proximity detection method according to the present invention is one for detecting proximity of a first portion to a second portion, the first portion being provided with action application means for contactlessly exerting a predetermined action. The method includes the steps of: monitoring a detection output of detection means for the action, the detection means being provided in the second portion; preventing the action by driving means for preventing, in the first portion, the action application means from exerting the action in response to that the detection output is turned on; and judging proximity as to whether or not the first portion is proximate to the second portion based on the detection output of the action detection means, the detection output corresponding to the prevention of the action.

In a preferred aspect, the proximity detection method may further include the step of turning on a noise flag when it is judged in the step of judging proximity that the first portion is not proximate to the second portion, and the step of preventing the action and the step of judging proximity are not performed while the noise flag is on even if the detection output of the action detection means is turned on. The proximity detection method also may further include the step of turning off the noise flag when the detection output of the action detection means is off and the noise flag is on.

A program of the present invention is characterized by allowing a computer to execute the steps included in any of the proximity detection methods.

### BRIEF DESCRIPTION OF DRAWINGS

Some of the purposes of the invention having been stated, others will appear as the description proceeds, when taken in connection with the accompanying drawings, in which:

FIG. 1 is a block diagram showing a notebook PC according to one embodiment of the present invention;

FIG. 2 is a flowchart showing processing by an MPU in the notebook PC of FIG. 1;

FIGS. 3(a) and 3(b) are waveform charts for explaining the processing in the flowchart of FIG. 2;

FIG. 4 is a view showing a notebook PC according to a conventional example, which is configured to detect by use of a magnetic sensor that a lid is closed; and

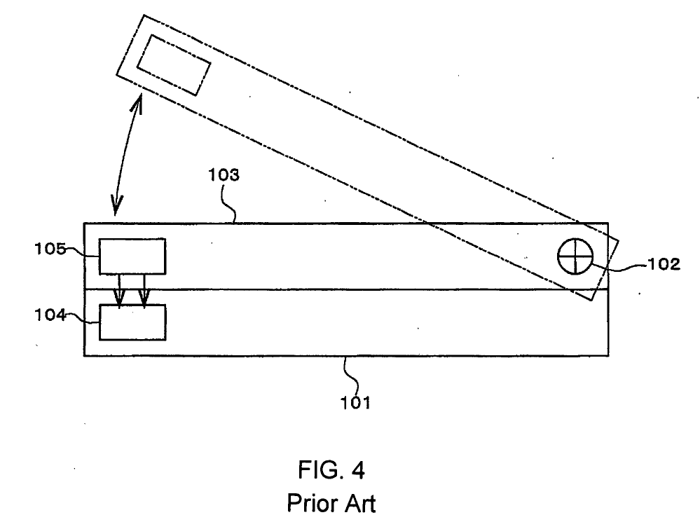

FIG. 5 is an explanatory view for explaining a problem in the notebook PC of FIG. 4.

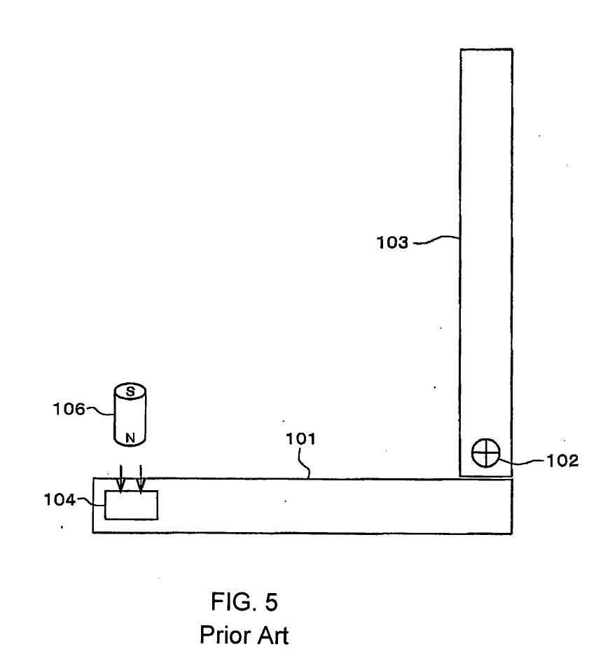

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

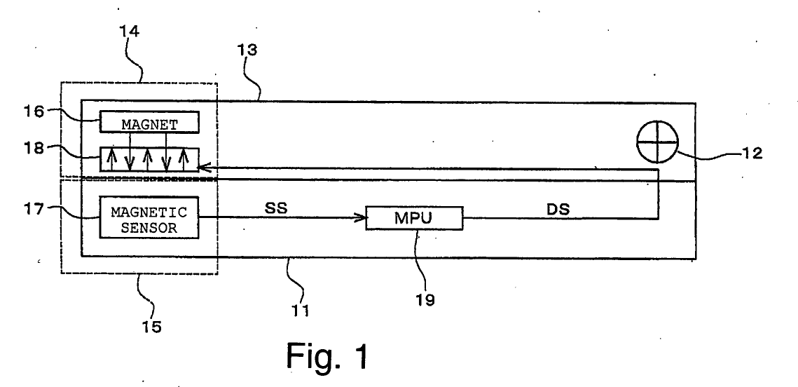

FIG. 1 is a block diagram showing a notebook PC according to one embodiment of the present invention. As shown in this diagram, this notebook PC includes a body 11 and a lid 13 which is pivotally connected to the body 11 through a hinge 12 to be openable. A keyboard and a motherboard on which a CPU, a memory and the like are attached are provided in the body 11. A liquid crystal display device which has a display screen on a side facing the body 11 when the lid 13 is closed is built in the lid 13. The notebook PC also includes a proximity detector for detecting whether or not a first portion 14, an end portion of the lid 13 on the opposite side to the hinge 12, is proximate to a second portion 15, part of the body 11 to which the first portion 14 becomes proximate when the lid 13 is closed.

This proximity detector includes a magnet 16 which is provided in the first portion 14 and contactlessly exerts an action of a magnetic field, a magnetic sensor 17 which is provided in the second portion 15 and detects the action of the magnetic field exerted by the magnet 16, a coil 18 which is provided in the first portion 14 and prevents the action of the magnetic field exerted by the magnet 16 on the magnetic sensor 17, and an MPU 19 which, based on an output of the magnetic sensor 17, drives the coil 18 and detects whether or not the first portion 14 is proximate to the second portion 15, that is, whether or not the lid 13 is closed.

The magnetic sensor 17 has a Hall effect switch, performs on/off control of an output of a predetermined voltage based on on/off operations of the Hall effect switch, and supplies the output of the predetermined voltage to the MPU 19. Specifically, when a magnetic field having an intensity of a predetermined value or more acts, an electromotive force of a predetermined value or more is generated in a Hall element by a Hall effect, and the Hall effect switch is turned on based on the electromotive force. In response to this, the magnetic sensor 17 supplies the output of the predetermined voltage to the MPU 19. The coil 18 is connected to a power supply through, for example, a switching transistor and is driven by the MPU 19 controlling ON/OFF of this transistor.

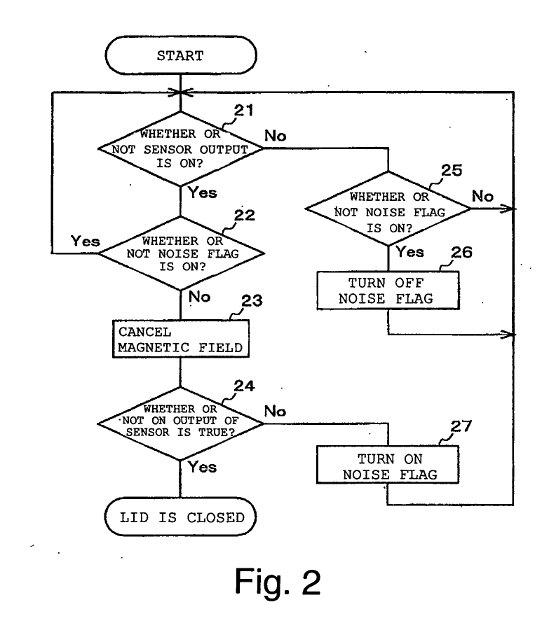

FIG. 2 is a flowchart showing processing by the MPU 19. When the processing is started, first in Step 21, it is judged whether or not the output of the magnetic sensor 17 is on. If the output is not on, the processing proceeds to Step 25, and if the output is on, the processing proceeds to Step 22. Here, as causes of turning on the magnetic sensor 17, the following cases are conceivable. In one case, when the lid 13 is closed and the first portion 14 becomes proximate to the second portion 15, the magnetic field acting on the magnetic sensor 17 due to the magnet 16 exceeds the predetermined intensity. In another case, a noise magnetic field acting on the magnetic sensor 17 due to other causes than the magnet 16 exceeds the predetermined intensity. As the other causes than the magnet 16, for example, a magnetic accessory which an operator wears, a magnetic clip present in the vicinity of the magnetic sensor 17, and an intense magnetic field environment caused by an electric furnace or the like are conceivable.

In Step 25, it is judged whether or not a noise flag is on. Incidentally, the noise flag is turned on in Step 27 to be described later. Here, the “noise flag is on” means that the notebook PC may be situated in such a state where the magnetic sensor 17 can be turned on by the noise magnetic field due to the other causes than the magnet 16. If the noise flag is not on, the processing returns to Step 21, and if the noise flag is on, the processing proceeds to Step 26. When the notebook PC is opened under an environment without the noise magnetic field, the MPU 19 comes into a state of repeating Steps 21 and 25 and of standing by until the output of the magnetic sensor 17 is turned on.

When the processing proceeds to Step 26, the noise flag is turned off, and the processing returns to Step 21. This is because there is a possibility that an influence of the noise magnetic field has disappeared because the output of the magnetic sensor 17 is turned off although the notebook PC was situated in the environment where the noise magnetic field was present.

In Step 22, it is judged whether or not the noise flag is on. If the noise flag is not on, the processing proceeds to Step 23, and if the noise flag is on, the processing proceeds to Step 21. If the output of the magnetic sensor 17 is on and the noise flag is on, Steps 21 and 22 are repeated. This is because the processing of Steps 23 and 24 to be described later, which consumes electric power, can be prevented from being wastefully performed in a continuous manner under the influence of the noise magnetic field.

In Step 23, the coil 18 is driven by a predetermined coded driving signal in response to that the output of the magnetic sensor 17 is turned on, and the magnetic field by the magnet 16 is canceled. As a result of this, based on what becomes of a detection signal by the magnetic sensor 17, it is judged in Step 24 whether the turning on of the output of the magnetic sensor 17 is a true one by the action of the magnetic field exerted by the magnet 16 or one relating to an erroneous detection by the action of the magnetic field due to the other causes. “The turning on of the output of the magnetic sensor 17 is a true one” means that the first portion 14 becomes proximate to the second portion 15 and that the lid 13 is closed to the body 11.

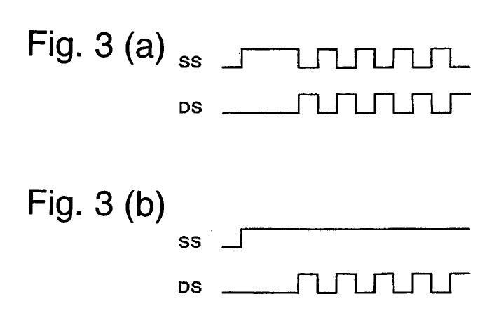

FIGS. 3(a) and 3(b) are schematic waveform charts for explaining the processing in Steps 23 and 24. As shown in these charts, in response to that an output SS of the magnetic sensor 17 is turned on, a driving signal DS for driving the coil 18 is applied in the magnetic field cancel processing of Step 23. The driving signal DS has a predetermined coded on/off pattern. Then, when the output of the magnetic sensor 17 is turned on because of the action of the magnetic field exerted by the magnet 16, as shown in FIG. 3(a), the output SS of the magnetic sensor 17 becomes a waveform of a pattern which is synchronous with the driving signal DS and reverse thereto in ON/OFF phase. This is because, when the coil 18 is driven by the driving signal DS, a magnetic field changed so as to correspond to the driving signal DS is formed by the coil 18, the magnetic field produced by the magnet 16 is thereby canceled, and a result of this appears on the output of the magnetic sensor 17.

On the other hand, when the output of the magnetic sensor 17 is turned on because of the action of the noise magnetic field exerted by something else other than the magnet 16, as shown in FIG. 3(b), the output SS of the magnetic sensor 17 remains in the ON state without being changed even if the coil 18 is driven by the pattern of the driving signal DS. This is because the magnetic field exerted by the something other than the magnet 16 acts on the magnetic sensor 17 in a continuous manner and maintains the output of the magnetic sensor 17 in the ON state because the magnetic field exerted by the something other than the magnet 16 cannot be canceled by the coil 18.

Hence, in Step 24, when the output SS of the magnetic sensor 17 shows the waveform canceled in response to the driving signal DS as shown in FIG. 3(a), it can be judged that the ON output of the magnetic sensor 17 is true. On the other hand, when the output SS of the magnetic sensor 17 remains in the ON state and is not canceled, it can be judged that the ON output of the magnetic sensor 17 is caused by a malfunction of the magnetic sensor 17 because of the noise magnetic field.

In Step 24, when it is judged that the ON output of the magnetic sensor 17 is true, it is regarded that the lid 13 is closed. In this case, the notebook PC can shift to the power saving mode. When it is judged that the ON output of the magnetic sensor 17 is caused by the malfunction of the magnetic sensor 17, the processing proceeds to Step 27.

In Step 27, the notebook PC is situated under the environment of such a noise magnetic field where the magnetic sensor 17 malfunctions, and therefore the noise flag showing this effect is turned on. When the noise flag is turned on, the processing returns from Step 22 to Step 21 as described above, and therefore the magnetic field cancel processing in Step 23 is not performed.

Here, suppose a case of using, as the magnetic sensor 17, one having a Hall effect switch turned on when a magnetic field of 30 (AT) is applied in a spatial permeability environment without providing a special magnetic circuit, and using, as the magnet 16, one capable of turning on the output of the magnetic sensor 17 when the lid 13 is closed. If a magnetic field of 21.6 (AT) is generated by the coil 18 in this case, the magnetic field of the magnet 16 can be canceled, which is confirmed by an experiment. In order to generate the magnetic field of 21.6 (AT), for example, a coil in which the number of turns is 80 and a resistance is 10 (Ω) may be used as the coil 18, and a current of 270 (mA) may be flowed therethrough by use of a power supply of 2.7 (V). Alternatively, a coil in which the number of turns is 100 and a resistance is 15 (Ω) may be prepared, and a current of 220 (mA) may be flowed therethrough by use of a power supply of 3.3 (V). Furthermore, it is satisfactory if the driving signal DS is one of a pulse waveform. Electric power to an extent as described above is sufficiently within a range of practical use of a usual notebook PC having a power supply of approximately 3 (V) and a load driving capability of approximately 200 (mA).

According to this embodiment, the magnetic field of the magnet 16 is prevented from acting on the magnetic sensor 17 when the magnetic sensor 17 detects the magnetic field of the predetermined intensity or more and turns on the output thereof. Moreover, based on this output of the magnetic sensor 17, it is judged whether the ON output of the magnetic sensor 17 is a true one by the action of the magnetic field of the magnet 16 or one relating to the erroneous detection because of the influence of the noise magnetic field. Accordingly, the erroneous judgment that the lid 13 is closed because of the influence of the noise magnetic field can be prevented. Moreover, when it is judged in Step 24 that the magnetic sensor 17 malfunctions by the action of the magnetic field exerted by something else other than the magnet 16, the noise flag is turned on, and after this the magnetic field cancel processing in Step 23 is not performed. Accordingly, the electric power can be prevented from being wastefully consumed by the repetition of the cancel processing.

Note that the present invention is not limited to the above-described embodiment, and can be embodied while being modified as appropriate. For example, although the magnetic field produced by the magnet 16 is detected by the magnetic sensor 17 and cancelled with the coil 18 in the above-described embodiment, instead of this, light by means of a light emitting device may be detected by a photodetector and shielded by a shutter. Moreover, although the present invention is applied to detect whether or not the lid 13 of the notebook PC is closed in the above-described embodiment, instead of this, the present invention may be applied to detect whether or not a door of a refrigerator is closed.

As described above, according to the present invention, when the action is detected by the action detection means, it is detected whether or not the first portion is proximate to the second portion based on the detection output of the action detection means in the case of preventing the action from the action application means. Accordingly, it can be prevented that the action detection means erroneously recognizes that the first portion is proximate to the second portion by detecting another action than the action from the action application means. Moreover, as the action application means, one requiring no supply of energy from the outside can be adopted.

In the drawings and specifications there has been set forth a preferred embodiment of the invention and, although specific terms are used, the description thus given uses terminology in a generic and descriptive sense only and not for purposes of limitation.

What is claimed is:

1. Apparatus comprising:
first and second members movable one relative to the other;
an element mounted in one of said members which initiates an action in the apparatus;
a detector mounted in the other of said members which responds to the proximity of and detects the intensity of interaction with said element; and
a inhibitor mounted in said one of said members which selectively inhibits the intensity of interaction between said element and said detector;
said inhibitor, said element and said detector cooperating in determining the physical proximity of said members one relative to the other and enabling an effective intensity of interaction between said element and said detector when said members are in close proximity one to the other.

2. Apparatus according to claim 1 wherein said element is free of any necessity of application of an external source of power.

3. Apparatus according to claim 1 wherein said detector responds to one of an electromagnetic wave, an electric field, a magnetic field, corpuscular radiation, and an acoustic wave.

4. Apparatus according to claim 1 wherein said element is a magnet, said detector is a Hall effect switch responsive to imposition of a magnetic field, and said inhibitor is a coil generating a magnetic field opposing the field of said magnet.

5. Apparatus according to claim 1 wherein said element is a light source, said detector is a photoelectric device, and said inhibitor is a light shield.

6. Apparatus according to claim 1 wherein one of said members is the lid of a portable computer system having a display therein and the other of said members is the body of a portable computer system having a keyboard therein.

7. Apparatus according to claim 1 wherein said inhibitor is responsive to a coded driving signal and further wherein said inhibitor, said element and said detector cooperate in determining the physical proximity of said members one relative to the other by detection of the coded driving signal.

8. Apparatus comprising:
a portable computer system body having a keyboard therein;
a portable computer system lid having a display therein;
a coupling joining said body and said lid together for movement thereof one relative to the other between open and closed positions; and
a proximity detection subsystem which determines whether said body and said lid are in the closed position, said subsystem comprising:
an element mounted in one of said body and said lid which initiates an action in the apparatus;
a detector mounted in the other of said body and said lid which responds to the proximity of and detects the intensity of interaction with said element; and
a inhibitor mounted in said one of said body and said lid which selectively inhibits the intensity of interaction between said element and said detector;
said inhibitor, said element and said detector cooperating in determining the physical proximity of said body and said lid one relative to the other and enabling an effective intensity of interaction between said element and said detector when said body and said lid are in the closed position one to the other.

9. Apparatus according to claim 8 wherein said element is a magnet, said detector is a Hall effect switch responsive to imposition of a magnetic field, and said inhibitor is a coil generating a magnetic field opposing the field of said magnet and further comprising a microprocessor operatively connected to control excitation of said coil.

10. A method comprising:
detecting reception of a signal interaction normally indicative of initiation of a system operation;
selectively inhibiting response to the detected reception; and
detecting the physical proximity of two members coupled for movement one relative to the other and determining the appropriateness of initiating the system operation from close proximity of the members.

11. A method comprising:
monitoring the output of a detector mounted in one of two members coupled for movement one relative to the other;
detecting an output normally indicative of initiation of a system operation;
selectively inhibiting response to the detected reception; and
detecting the physical proximity of the members and determining the appropriateness of initiating the system operation from close proximity of the members.

12. A method according to claim 11 wherein the selective inhibition of response occurs in response to detection that the members are withdrawn one from the other.

13. A method according to claim 11 wherein selective inhibition of response is discontinued in response to detection that the members are in close proximity one to the other.

14. A computer program product comprising a computer readable medium and code stored on the medium which is effective when executing in a computer system to cause the system to perform the steps of one of claim 10.

15. A computer program product comprising a computer readable medium and code stored on the medium which is effective when executing in a computer system to cause the system to perform the steps of one of claim 11.
